(19) United States
(12) Patent Application Publication
(10) Pub. No.: US 2013/0087492 A1
(43) Pub. Date: Apr. 11, 2013

(54) Slurry drip dryer

(71) Applicant: Anthony Michael Lea, Las Vegas, NV (US)

(72) Inventor: Anthony Michael Lea, Las Vegas, NV (US)

(21) Appl. No.: 13/200,957

(22) Filed: Oct. 5, 2011

(51) Int. Cl. B01D 29/80

(52) U.S. Cl. 210/241; 210/483

(57) ABSTRACT

This device is designed to separate liquid from matter, or water from ground up cement or concrete. Water is recycled from the bi-product heavy grey mud or slurry, drying up the left-over matter. This process is possible through absorption containment liquid gravity filtration, This makes the water follow toward the adsorption gravite route of exite, or drip drying. The slurry liquid or matter is suspended in an absorbent filtration by using gravity to push the water out. The filter is designed in such a way that the water drips into the desired place.

### FIELD OF THE INVENTION

This device is designed to separate liquid from matter, or water from ground up cement or concrete. Water is recycled from the bi-product heavy grey mud or slurry, drying up the left-over matter.

This process is possible through absorption containment liquid gravity filtration, or drip drying. The slurry liquid or matter is suspended in an absorbent filtration by using gravity to push the water out. The filter is designed in such a way that the water drips into the desired place.

One filtration option is to make a frame and hang an absorbent filter bag designed like a funnel—larger at the top, while narrow and closed at the bottom of the bag. The frame will be used to suspend the bag off of the ground, while a pan remains underneath the bag to collect the dripping water. Usage of the proper filter bag, with the average cotton or wool thread count, will ensure that the water will drip clear and can be recycled for further cutting, grinding, and polishing applications. The assemblage of wheels on the frame creates mobility for technician convenience.

The mud or matter will sink to the bottom of the filter. The water will rise up, but also leak throughout the bag. It is intended to do so. The eyebolt's purpose is for hanging of the filtration bag, which subsequently rings out more water from the bag. The frame will have easy assembly and disassembly for transportation convenience throughout the job and travel.

Average size of the product would be 5′ high by 2′6″ in each of width and length. “Slurry Drip Dryer” filter device will be produced as requested by size. Sizes can vary, and will be determined depending on amount of slurry that will be dried. The filter bag has an opening hatch on the bottom for easy product removal of leftover matter.

### BRIEF DESCRIPTION OF THE DRAWINGS

FIG. 1a Is A perspective front view of Slurry Drip Dryer frame.

FIG. 1b Is A Front view of slurry drip dryer frame.

FIG. 2 Is A perspective front view of absorbant filter container.

FIG. 3 Is A perspective front view of exploded plan cutaway view of absorbant filter container, to view absorbant chambers.

FIG. 4a Is A perspective front view of slurry drip dryer. A invention that achieves claims 1 and 2.

FIG. 4b Is a front view of slurry drip dryer.

### DETAILED DESCRIPTION

Is A representation of the process according to the invention.

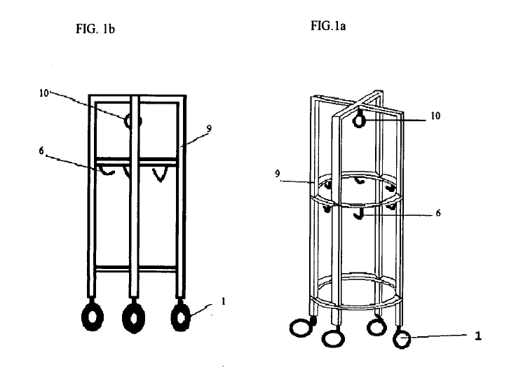

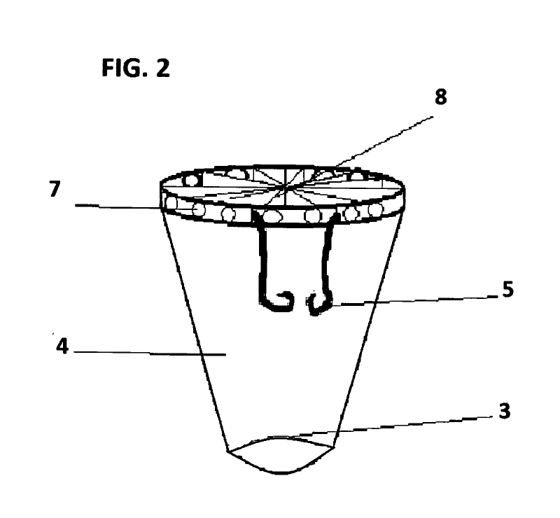

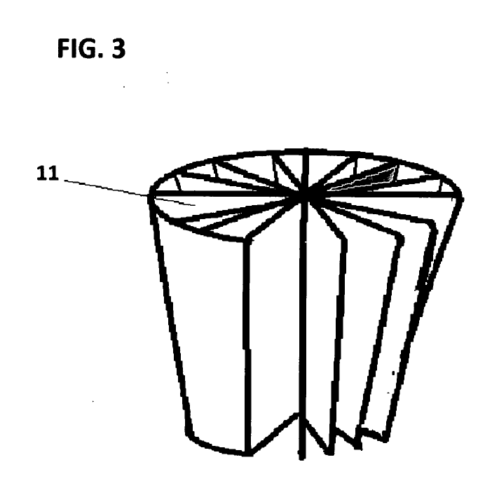

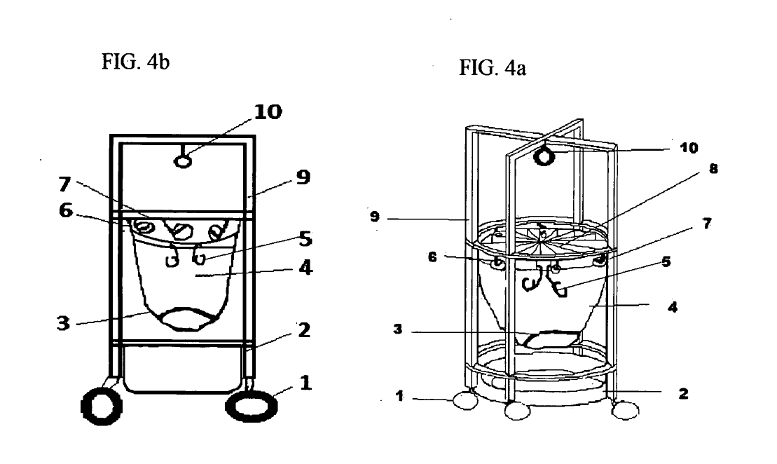

FIG. 1a The assemblage of wheels on the frame creates mobility for technician convence.

2, Pan remains underneath the bag to collect the expelled water. The water can be recycled for further cutting, grinding, and polishing applications.

3, The filtration container has an opening hatch on the bottom for easy product removal of leftover matter.

4, The filter is extremely absorbant and has specially designed chambers that use absorption, gravity and the wicking process to dry slurry and other matter. The best design for this process is shaped like a funnel-larger at the top, while narrow and closed at the bottom of the bag or container. The inside of the filter or container has a inner shell that has specially designed chambers which have equal parts connected to the inside walls and bottom of the bag. This makes the water follow toward the adsorption gravity route of exit. The frame will be used to suspend the slurry containment off of the ground, while a pan remains underneath the bag to collect the expelled water. Best usage of the proper slurry containment absorption, with the average cotton or wool thread count, will ensure that the expelled water will be expelled clearly and can be recycled for further cutting, grinding, and polishing applications. The slurry or matter will sink to the bottom of the filter container. As the slurry or matter settles to the bottom of the filtration container, the water rises up. It is then absorbed into the filtration container and then expelled throughout the filtration container, thus starting the dying process. This is the intended process.

5, Draw rope with hooks to help contain slurry or matter. Also for repositioning slurry or matter. This rope system aids in the positioning of the filtration container to speed up drying and also makes it possible for the removal of the slurry or matter.

6, Hooks on frame to hold and suspend filter container. Acts like a strainer or a catch and makes for easy product removal of left over slurry or matter.

7, Grommets give the filter bag strength and are used to suspend the filtration container or bag like a strainer or a catch.

8, Inside of the filter bag there is an inner shell that has specially designed chambers that have equal parts connected to the inside walls and bottom of the bag. This make the water follow toward adsorption gravity route of exit.

9, The frame will be used to suspend filtration container or bag, off of the ground, to allow the process slurry containment absorption gravity drying filtration. The frame will have easy assembly and disassembly for transportation convenience throughout the job and travel. Average size the product would be 5′ high by 2′6″ in each of width and length. “Slurry Drip Dryer” device and filters will be produced as requested by size. Sizes can vary, and will be determined depending on amount of slurry or matter that will be dried.

10, The eyebolt's purpose is for hanging of the filtration container or bag, making it easier to wrench more water out from the bag.

11, Inner chambers with ¼ shell to show what the specially designed chambers might look like. This has an inner shell that has specially designed chambers that have equal parts connected to the inside walls and bottom of the bag. This make the water follow toward adsorption gravity route of exit.

1. The fully adjustable frame on wheels, which can be made any size as well as assembles and disassembles easily, utilizes a specially designed chambered filter that works like catch or strainer, thus separating liquid from slurry or matter making it possible to contain the liquid for recycling and drying the slurry or matter.

2. The specially designed chambered filter is made with absorbent materials with the frame suspending it off the ground using gravity and the wicking process to help facilitate the separating of the liquid and afterwards can be wrung dry in its hanging position before the release hatch is opened for product removal.
